(19) United States
(12) Patent Application Publication
(10) Pub. No.: US 2019/0292938 A1
(43) Pub. Date: Sep. 26, 2019

(54) GAS TURBINE ENGINE WASH SYSTEM

(71) Applicant: General Electric Company, Schenectady, NY (US)

(72) Inventor: Peng WANG, Shanghai (CN)

(21) Appl. No.: 16/341,698

(22) PCT Filed: Oct. 14, 2016
(86) PCT No.: PCT/CN2016/102127

§ 371 Date: Apr. 12, 2019

(51) Int. Cl. F01D 25/00; B08B 3/02

(52) U.S. Cl. CPC F01D 25/002; B08B 3/02; B08B 2203/027; F05D 2260/607; F05D 2230/72

(57) ABSTRACT

A water wash system (10) for a gas turbine engine includes a pump (50) configured to receive a flow of wash liquid and pressurize the flow of wash liquid. The water wash system additionally includes a nozzle distribution assembly (56) fluidly connected to the pump, and a plurality of wash lines (58) fluidly connected to the nozzle distribution assembly. Further, a plurality of spray nozzles (74) are included, with each of the plurality spray nozzles attached to a respective wash line and configured for extending at least partially into or through one or more borescope holes (146) of the gas turbine engine for providing a portion of the flow of pressurized wash liquid to the gas turbine engine.

### FIELD OF THE INVENTION

The present subject matter relates generally to a water wash system for a gas turbine engine, and a method for operating the same.

### BACKGROUND OF THE INVENTION

Typical aircraft propulsion systems include one or more gas turbine engines. For certain propulsion systems, the gas turbine engines generally include a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

During operation, a substantial amount of air is ingested by such gas turbine engines. However, such air may contain foreign particles. A majority of the foreign particles will follow a gas path through the engine and exit with the exhaust gases. However, at least certain of these particles may stick to certain components within the gas turbine engine's gas path, potentially changing aerodynamic properties of the engine and reducing engine performance.

In order to remove such foreign particles from within the gas path of the gas turbine engine, water or other liquids may be directed towards an inlet of the gas turbine engine, while the core engine is cranked using, e.g., a starter motor. Such movement may enhance the wash results by mechanical engagement between the water and components. Additionally, such rotation may also urge the water through the engine and out the exhaust section.

However, with such operations, the wash fluid may lose pressure and/or temperature by the time it reaches certain downstream locations of the gas turbine engine, potentially reducing an efficiency of the washing operations. Accordingly, a system for providing heated and/or pressurized wash liquid at downstream locations of an inlet of the gas turbine engine would be useful.

### BRIEF DESCRIPTION OF THE INVENTION

Aspects and advantages of the invention will be set forth in part in the following description, or may be obvious from the description, or may be learned through practice of the invention.

In one embodiment of the present disclosure, a water wash system for a gas turbine engine is provided. The gas turbine engine defines an axial direction and includes a plurality of borescope holes. The water wash system includes a pump configured to receive a flow of wash liquid and to pressurize the flow of wash liquid. The water wash system also includes a nozzle distribution assembly fluidly connected to the pump for receiving the flow of pressurized wash liquid. The water wash system also includes a plurality of wash lines fluidly connected to the nozzle distribution assembly. The water wash system also includes a plurality of spray nozzles, each of the plurality of spray nozzles attached to a respective wash line and configured for extending at least partially into or through one of the borescope holes of the gas turbine engine for providing a portion of the flow of pressurized wash liquid to the gas turbine engine.

In another exemplary embodiment of the present disclosure a gas turbine engine is provided. The gas turbine engine includes a turbine engine having a compressor section, a combustion section, and a turbine section in serial flow communication. The turbine engine defines a plurality of borescope holes located within one or more of the compressor section, the combustion section, and the turbine section. The gas turbine engine also includes a wash system for washing the turbine engine. The wash system includes a pump for receiving a flow of wash liquid and pressurizing the flow of wash liquid, and a nozzle distribution assembly fluidly connected to the pump for receiving the flow of pressurized wash liquid. The wash system also includes a plurality of wash lines fluidly connected to the nozzle distribution assembly, and a plurality of spray nozzles. Each of the plurality of spray nozzles is attached to a respective wash line and extends at least partially into or through one of the borescope holes of the gas turbine engine for providing a portion of the flow of pressurized wash liquid to the turbine engine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a water wash system in accordance with an exemplary embodiment of the present disclosure.

FIG. 2 is a schematic view of a tank module in accordance with an exemplary embodiment of the present disclosure, as may be incorporated in the exemplary water wash system of FIG. 1.

FIG. 3 is a schematic view of a power wash module in accordance with an exemplary embodiment of the present disclosure, as may be incorporated in the exemplary water wash system of FIG. 1.

FIG. 4 is a schematic view of a nozzle distribution assembly in accordance with an exemplary embodiment of the present disclosure, as may be incorporated in the exemplary power wash module of FIG. 3.

FIG. 5 is a schematic view of a power wash module in accordance with an exemplary embodiment of the present disclosure, operable with a gas turbine engine in accordance with an exemplary embodiment of the present disclosure.

FIG. 6 is a schematic, close up view of a compressor section of the exemplary gas turbine engine of FIG. 5.

FIG. 7 is a schematic, axial view of the compressor section of the exemplary gas turbine engine of FIG. 5.

FIG. 8 is a schematic view of a combustion section of the exemplary gas turbine engine of FIG. 5.

FIG. 9 is a flow diagram of a method for washing a turbine engine of a gas turbine engine in accordance with an exemplary aspect of the present disclosure.

FIG. 10 is a flow diagram of a method for washing a turbine engine of a gas turbine engine in accordance with another exemplary aspect of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

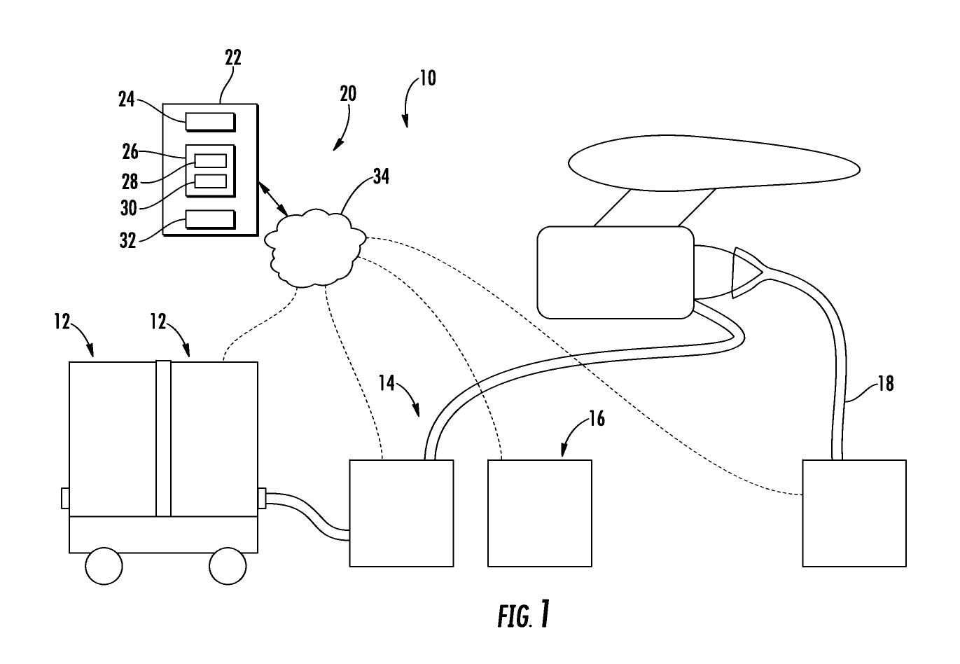

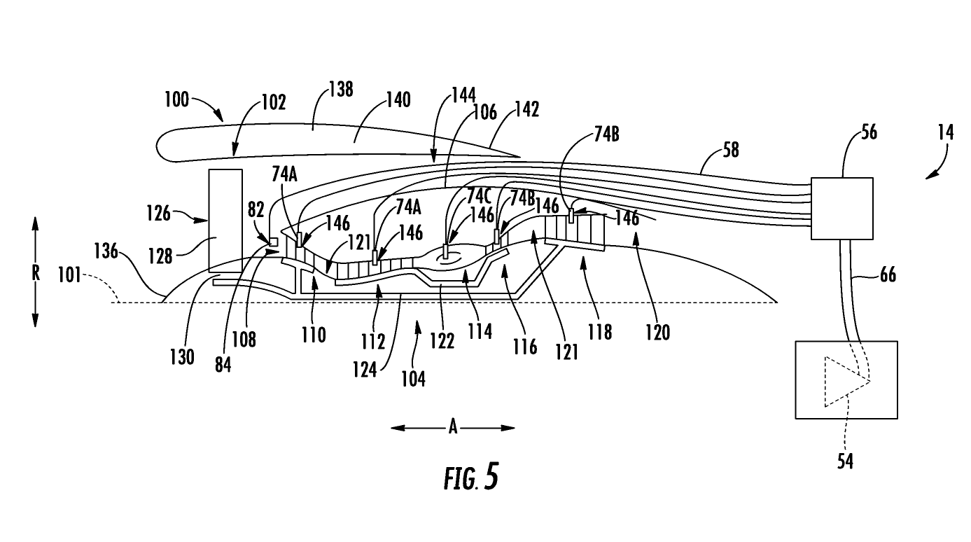

Referring now to the drawings, wherein identical numerals indicate the same elements throughout the figures, FIG. 1 provides a schematic view of a water wash system 10 in accordance with an exemplary embodiment of the present disclosure. The exemplary water wash system 10 is configured for use with a gas turbine engine, such as a turbofan gas turbine engine (e.g., turbofan 100; see FIG. 5). Additionally, or alternatively, however, the water wash system 10 may be utilized with any other suitable gas turbine engine, such as a turboprop engine, a turboshaft engine, turbojet engine, etc.

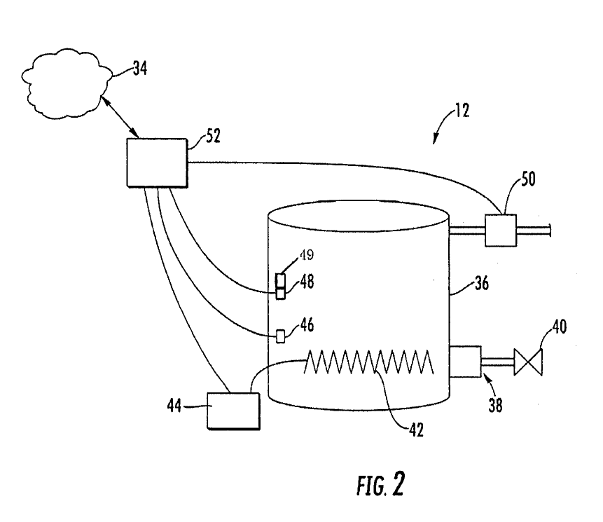

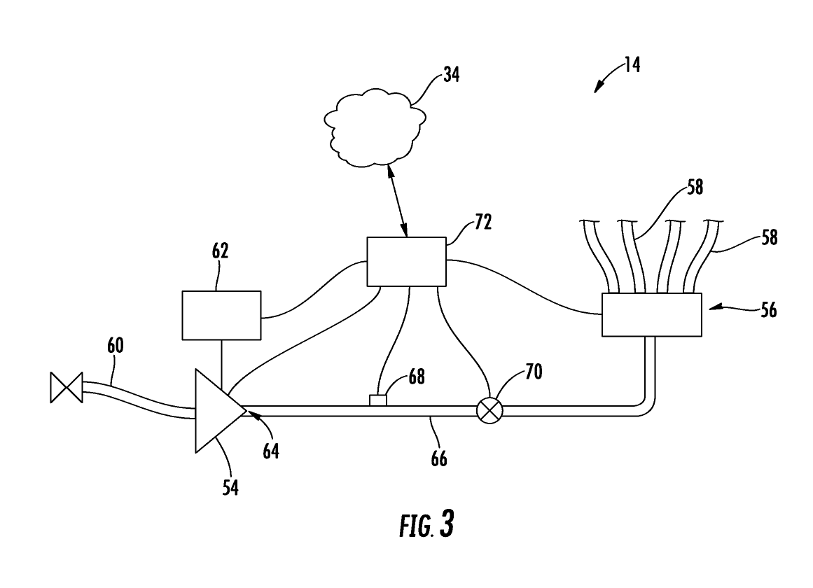

The exemplary water wash system 10 of FIG. 1 is configured as a modular system. Specifically, the water wash system 10 generally includes one or more tank modules 12 (see, e.g., FIG. 2), a power wash module 14 (see, e.g., FIG. 3), a foam wash module 16, and a collection module 18. Each of the various modules are, for the embodiment depicted, operably connected to a control system 20. The control system 20 may include one or more computing device(s) 22. The computing device(s) 22 may include one or more processor(s) 24 and one or more memory device(s) 26. The one or more processor(s) 24 may include any suitable processing device, such as a microprocessor, microcontroller, integrated circuit, logic device, or other suitable processing device. The one or more memory device(s) 26 may include one or more computer-readable media, including, but not limited to, non-transitory computer-readable media, RAM, ROM, hard drives, flash drives, or other memory devices.

The one or more memory device(s) 26 may store information accessible by the one or more processor(s) 24, including computer-readable instructions 28 that can be executed by the one or more processor(s) 24. The instructions 28 can be any set of instructions that when executed by the one or more processor(s) 24, cause the one or more processor(s) 24 to perform operations. The instructions 28 may be software written in any suitable programming language or can be implemented in hardware. In some embodiments, the instructions 28 may be executed by the one or more processor(s) 24 to cause the one or more processor(s) 24 to perform operations, such as the washing operations of a gas turbine engine, as described herein, and/or any other operations or functions of the one or more computing device(s) 22. Additionally, and/or alternatively, the instructions 28 may be executed in logically and/or virtually separate threads on processor 24. The memory device(s) 26 can further store data 30 that can be accessed by the processors 24.

The computing device(s) 22 can also include a communications interface 32 used to communicate, for example, with the other components of water wash system 10. The communications interface 32 may include any suitable components for interfacing with one more communications network(s), including for example, transmitters, receivers, ports, controllers, antennas, or other suitable components. Control system 20 may also be communication (e.g., via communications interface 32) with the various modules 12, 14, 16, 18, described below, and may selectively operate the water wash system 10 in response to user input and feedback from these modules 12, 14, 16, 18. More specifically, for the embodiment depicted, the control system 20 is configured to communicate through a wireless communication network 34 through the interface 32, such that the control system 20 may send or receive information and/or commands to or from the various modules 12, 14, 16, 18 of the exemplary water wash system 10 wirelessly. It should be appreciated, however, that in other embodiments, the control system 20 may additionally, or alternatively, use a wired communication bus to communicate with various modules 12, 14, 16, 18.

The technology discussed herein makes reference to computer-based systems and actions taken by and information sent to and from computer-based systems. It should be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel. For example, although the exemplary control system 20 is depicted as including a separate computing device 22, in certain embodiments, the computing device 22 may be included within, e.g., one or more of the modules 12, 14, 16, 18, an onboard computing device of an aircraft, a controller of a gas turbine engine, etc.

Referring still to FIG. 1, the tank module 12, as further discussed below with reference to FIG. 2 may generally include a wash tank 36 for containing a wash fluid, or rather, a wash liquid, and defining an outlet 38. Additionally, the power wash module 14 of the water wash system 10 may be configured to be releasably fluidly connected to one or more tank modules 12 to receive wash liquid from such tank module(s) 12. The power wash module 14, as further described below with reference to, e.g., FIG. 3, may further be configured for pressurizing the wash liquid received, and providing such pressurized wash liquid to the gas turbine engine for washing the gas turbine engine. The foam wash module 16 may be configured in a similar manner to the exemplary power wash module 14, however may be configured to receive wash liquid from the one or more tank modules 12, process the wash liquid to form wash foam, and provide such wash foam to the gas turbine engine for washing. Finally, the collection module 18 may be configured to collect waste wash liquid/foam and air from an exhaust of the gas turbine engine, and contain the collected waste wash liquid/foam and air.

It should be appreciated, that as used herein the term “wash liquid” may refer to any suitable liquid for performing washing operations of the gas turbine engine. For example, the wash liquid may refer to water, or a combination of water and detergent, soap, and/or other additives. Moreover, although the wash system is described as a “water wash system 10”, the system is not limited to utilizing water as a wash liquid. The water wash system 10 may utilize any suitable wash liquid for performing desired washing operations of the gas turbine engine.

A water wash system including one or more of the exemplary modules described herein may allow for a more versatile water wash system for a gas turbine engine. For example, utilizing tank modules that are interchangeable with a power wash module and/or a foam wash module may allow for extended washing operations, without having to refill a wash tank and wait for the wash liquid in such wash tank to heat up to a desired temperature. Instead, once all of a wash liquid within a given tank module has been utilized by the water wash system, a second tank module may be fluidly connected to the power wash module to allow for the washing operations to continue with minimal interruption. Similarly, utilizing a power wash module that is interchangeable with, e.g. a foam wash module may allow for multiple wash operations to be completed on a given gas turbine engine without requiring two completely separate water wash systems.

Additionally, as stated, the exemplary water wash system may be controlled through a control system in communications with a wireless network. Accordingly, the control system may be operably connected to the various modules through a wireless communication network, and further, may receive control signals/commands through a wireless communication network. Such a configuration may allow for an operator located remotely from the wash system, such as an operator within a cockpit of an aircraft, to wirelessly control certain aspects of the water wash system.

Referring now particularly to FIG. 2, a schematic view of a tank module 12 in accordance with an exemplary aspect of the present disclosure is provided. The exemplary tank module 12 of FIG. 2 may be utilized with the exemplary water wash system 10 described above with reference to FIG. 1. As is depicted the exemplary tank module 12 includes a wash tank 36 for containing a wash fluid, or rather a wash liquid. The wash tank 36 further defines an outlet 38. The outlet 38 of the wash tank 36 is fluidly connected to a quick release connection 40, allowing for the wash tank 36 to be quickly, easily, and reversibly fluidly connected to, e.g., a power wash module 14 or a foam wash module 16 of a water wash system 10.

Moreover, the exemplary tank module 12 includes a heater 42 in thermal communication with the wash liquid within the wash tank 36. The heater 42 for the embodiment depicted is an electric resistance heater electrically connected to a power source 44. The power source 44 may be a battery, or any other suitable power source 44. It should be appreciated, however, that in other embodiments, the heater 42 may be configured in any other suitable manner (i.e., as any other suitable kind of heater) for heating the wash liquid within the wash tank 36.

The tank module 12 further includes one or more sensors. The sensors may include a temperature sensor 46 for sensing a temperature of the wash liquid within the wash tank 36, a water level sensor 48, and a pressure sensor 49. Additionally, for the embodiment depicted, the tank module 12 includes a pump 50 for pumping wash liquid into the wash tank 36 when connected with a liquid source (such as a hose, faucet, or a liquid storage container). The tank module 12 further includes a controller 52 operably connected to the power source 44 and heater 42, the sensors 46, 48, 49 and the pump 50. The controller 52 may configured similar to the computing device 22 of the control system 20, and may be in communication with the control system 20 of the water wash system 10 through, e.g., a wireless communication network 34.

It should be appreciated, however, that the exemplary tank module 12 depicted is provided by way of example only, and that in other exemplary embodiments, the tank module 12 may be configured in any other suitable manner. For example, in other embodiments, the tank module 12 may include features not described herein, or alternatively, may not include one or more of the features described herein.

Referring now to FIG. 3 a schematic view is provided of a power wash module 14 in accordance with an exemplary aspect of the present disclosure. The exemplary power wash module 14 of FIG. 3 may, in certain exemplary embodiments, be utilized with the exemplary water wash system 10 described above with reference to FIG. 1. However, it should be appreciated, that in other embodiments the power wash module 14 described with reference to FIG. 3 may instead be utilized with any other suitable water wash system 10, such as a single, integrated wash system.

The exemplary power wash module 14 of FIG. 3 generally includes a pump 54, and nozzle distribution assembly 56, and a plurality of wash lines 58. More specifically the pump 54 is configured to receive a flow of wash liquid and pressurize the flow of wash liquid. The pump 54 is configured to be releasably fluidly connected to an outlet 38 of a wash tank 36 of a wash tank module 12. For example, for the embodiment depicted, the power wash module 14 includes a fluid connection line 60, with the fluid connection line 60 configured to be releasably fluidly connected to an outlet 38 of a wash tank 36 of a wash tank module 12. For example, when utilized with the exemplary wash tank module 12 of FIG. 2, the fluid connection line of the power wash module 14 may be releasably fluidly connected to the outlet 38 through a quick release connection 40.

Although not depicted, the pump 54 may include a variable frequency drive motor, such that it may operate at various power levels. However, in other embodiments, any other suitable pump may be utilized, including any other suitable type of motor (such as a constant frequency motor). Additionally, as shown, the pump 54 is electrically connected to a power source 62, which may be a battery, or any other suitable power source. The power source 62 may provide the pump 54 with a necessary amount of electrical power to pressurize the wash liquid received to a desired pressure.

An outlet 64 of the pump 54 is fluidly connected to a duct 66 extending to the nozzle distribution assembly 56, such that the nozzle distribution assembly 56 is fluidly connected to the pump 54 for receiving a flow of pressurized wash liquid from the pump 54. For the embodiment depicted, upstream of the nozzle distribution assembly 56, the power wash module 14 includes a sensor 68 for, e.g., sensing a temperature and or pressure, and a valve 70. The valve 70, for the embodiment depicted, is positioned in the duct 66 and movable between an open position allowing full flow of wash liquid through the duct 66 and a closed position, preventing any flow of wash liquid through the duct 66. In certain exemplary embodiments, the valve 70 may be a variable throughput valve movable between various positions between the open position and the closed position to allow a desired amount of wash liquid through the duct 66.

Referring still to FIG. 3, for the embodiment depicted, the nozzle distribution assembly 56 is configured to receive a flow of wash liquid from the duct 66 (i.e., a flow of pressurized wash liquid from the pump 54), and distribute such flow of wash liquid to the plurality of wash lines 58. The nozzle distribution assembly 56 may be operably connected to a controller 72 of the power wash module 14. Notably, the controller 72 may further be operably connected to various other components of the power wash module 14. Specifically, for the embodiment depicted, the controller 72 is operably connected to the power source 62, the pump 54, the sensor 68, and the valve 70, in addition to the nozzle distribution assembly 56. The controller 72 may be configured similar to the computing device 22 of the control system 20, and may be in communication with the control system 20 of the water wash system 10 through, e.g., a wireless communication network 34. For example, as will be described in greater detail below, the controller 72 may be configured to control a flow of pressurized wash liquid to the plurality of wash lines 58 through the nozzle distribution assembly 56.

Moreover, as is depicted, the plurality of wash lines 58 are fluidly connected to the nozzle distribution assembly 56 for receiving at least a portion of the pressurized wash liquid therefrom. Although for the embodiment depicted, the nozzle distribution assembly 56 is fluidly connected to four (4) wash lines 58, in other embodiments, the power wash module 14 of the water wash system 10 may instead include any other suitable number of wash lines 58 fluidly connected to the nozzle distribution assembly 56. As will be appreciated from the description below, the nozzle distribution assembly 56 may be configured, in certain embodiments, to distribute the flow of pressurized wash liquid in a fixed manner. For example, the nozzle distribution assembly 56 may be configured to split the flow of pressurized wash liquid substantially evenly between each of the plurality of wash lines 58 fluidly connected thereto. Additionally, or alternatively, the nozzle distribution assembly 56 may be configured to split the flow of pressurized wash liquid in an uneven manner between the plurality of wash lines 58 fluidly connected thereto (i.e., distributing more wash liquid to certain wash lines 58 than others). In still other exemplary embodiments, the nozzle distribution assembly 56 may be configured to vary a distribution of the flow of the pressurized wash liquid between the various wash lines 58 according to, e.g., individual spray schedules for the various wash lines 58.

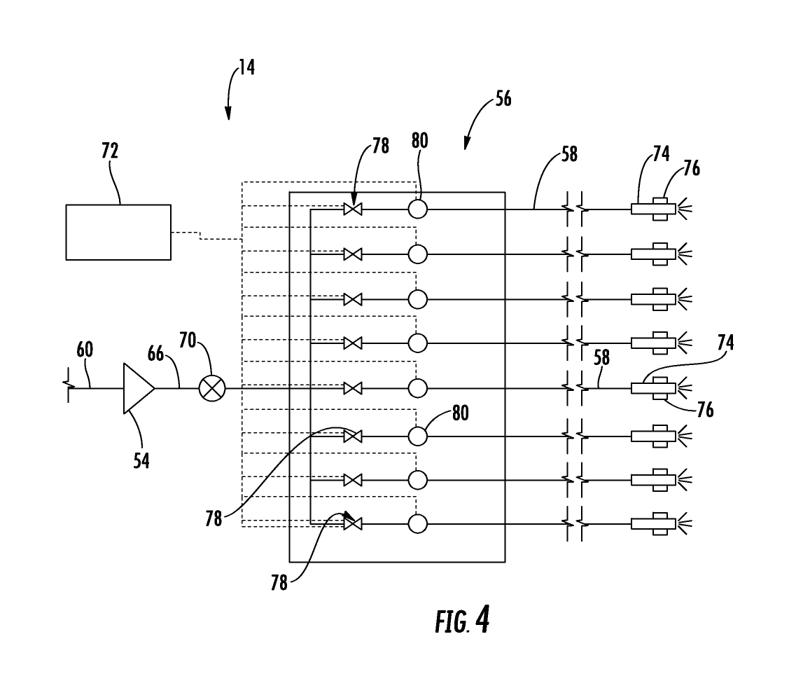

For example, referring now to FIG. 4, a water wash system 10, or more particularly, a power wash module 14 including a nozzle distribution assembly 56, in accordance with another exemplary embodiment of the present disclosure is depicted. As with the embodiment of FIG. 3, the exemplary nozzle distribution assembly 56 is fluidly connected to the pump 54 of the power wash module 14 via a duct 66. Additionally, as is discussed in greater detail below, the power wash module 14 further includes a plurality of spray nozzles 74, with each spray nozzle 74 attached to a respective wash line 58. As is also discussed in greater detail below, each of the plurality of spray nozzles 74 includes an attachment portion 76 for attachment to a respective borescope hole in a gas turbine engine.

Furthermore, the exemplary nozzle distribution assembly 56 is configured to vary a distribution of the flow of pressurized wash liquid between the various wash lines 58. Specifically, the nozzle distribution assembly 56 includes a plurality of valves 78, with each of the plurality of valves 78 fluidly connecting a respective wash line 58 to the pump 54. Each of the valves 78 may be a variable throughput valve movable between a fully open position allowing complete flow of pressurized wash liquid therethrough, a fully closed position allowing no flow of pressurized liquid therethrough, as well as a variety of positions therebetween. For example, one or more of the variable throughput valves 78 may be configured as solenoid valves, or solenoid activated valves, or alternatively as ratio regulation valves.

Moreover, for the embodiment depicted each of the plurality of valves 78 is individually operably connected to the controller 72, such that the plurality of valves 78 are operable independently of one another. Accordingly, the controller 72 may control the plurality of valves 78 such that each operates according to its own unique flow schedule (e.g., flow rate, pressure, duration, etc.).

In addition to the plurality of valves 78, the nozzle distribution assembly 56 further includes a plurality of flow meters 80, wherein each flow meter 80 is in fluid communication with a wash line 58 of the plurality of wash lines 58 to measure a flowrate of the pressurized wash liquid flowing therethrough. More specifically, for the embodiment depicted, the nozzle distribution assembly 56 includes a flow meter 80 downstream from each of the valves 78, for measuring a flowrate of wash liquid flowing to (and through) each wash line 58. However, in other embodiments, one or more of the flow meters 80 may instead be positioned upstream of a respective valve 78, or at any other suitable location.

As with the plurality of valves 78, each of the flow meters 80 is operably connected to the controller 72, such that the controller 72 may receive information indicative of a flowrate of wash liquid through each wash line 58 from the respective flow meters 80. The controller 72 may utilize such information in controlling one or more of the plurality of valves 78. For example, the controller 72 may operate on a feedback loop to ensure wash liquid is flowing to and through a particular wash line 58 at a desired flow rate.

Referring now to FIG. 5, a schematic view of a power wash module 14 of a water wash system 10 in accordance with an exemplary embodiment of the present disclosure is depicted, being utilized in washing operations of a gas turbine engine. In certain exemplary embodiments, the power wash module 14 of FIG. 5 may be configured in substantially the same manner as exemplary power wash module 14 of FIG. 3, of FIG. 4, and/or utilized in the exemplary water wash system 10 of FIG. 1. For example, the exemplary power wash module 14 generally includes a pump 54, a nozzle distribution assembly 56 fluidly connected to the pump 54 for receiving a flow of pressurized wash fluid therefrom, and a plurality of wash lines 58 fluidly connected to the nozzle distribution assembly 56.

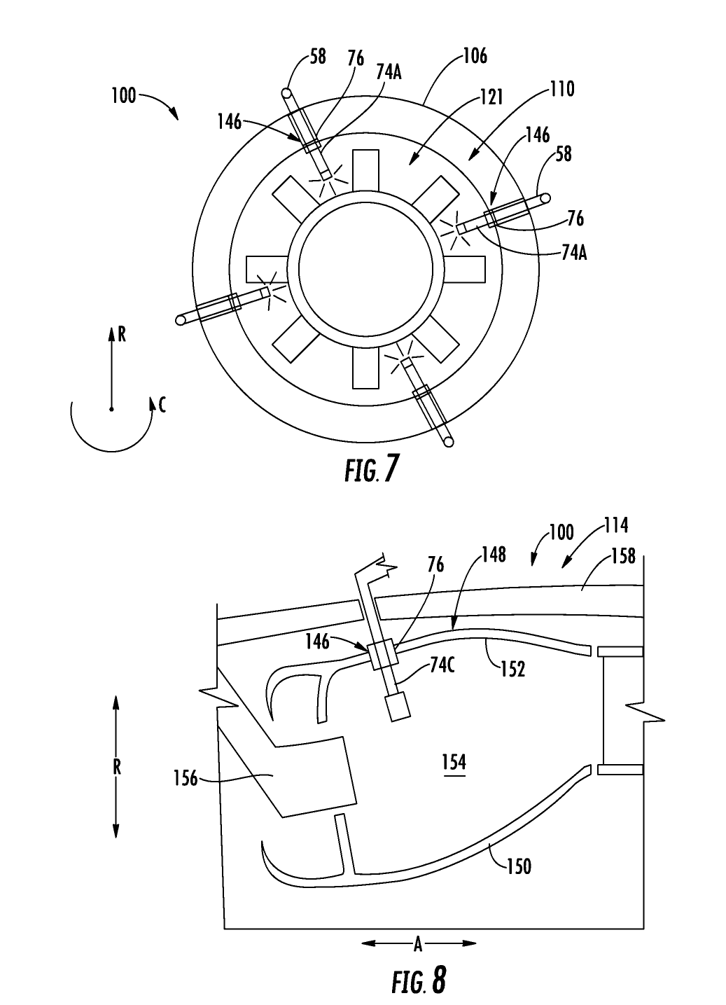

As stated, the exemplary power wash module 14 is being utilized in the embodiment depicted in FIG. 5 in washing operations of a gas turbine engine, also depicted schematically. The exemplary gas turbine engine depicted is configured as a high bypass turbofan engine, referred to herein as “turbofan 100.” As is depicted, the exemplary turbofan 100 defines an axial direction A (extending parallel to a longitudinal centerline 101 provided for reference), a radial direction R, and a circumferential direction C (extending about the axial direction A; see FIG. 7). Additionally, the turbofan 100 includes a fan section 102 and a turbine engine 104 disposed downstream from the fan section 102. The exemplary turbine engine 104 depicted generally includes a substantially tubular outer casing 106 that defines an annular inlet 108. The outer casing 106 encases, in serial flow relationship, a compressor section including a second, booster or low pressure (LP) compressor 110 and a first, high pressure (HP) compressor 112; a combustion section 114; a turbine section including a first, high pressure (HP) turbine 116 and a second, low pressure (LP) turbine 118; and a jet exhaust nozzle section 110. The compressor section, combustion section 114, and turbine section together define a core air flowpath 121 extending from the annular inlet 108 through the LP compressor 110, HP compressor 112, combustion section 114, HP turbine 116 section 116, LP turbine section 118 and jet nozzle exhaust section 120. A first, high pressure (HP) shaft or spool 122 drivingly connects the HP turbine 116 to the HP compressor 112. A second, low pressure (LP) shaft or spool 124 drivingly connects the LP turbine 118 to the LP compressor 110.

For the embodiment depicted, the fan section 102 includes a fan 126 having a plurality of fan blades 128 coupled to a disk 130 in a spaced apart manner. As depicted, the fan blades 128 extend outwardly from disk 130 generally along the radial direction R. In certain exemplary aspects, the fan 126 may be a variable pitch fan, such that each of the plurality of fan blades 128 are rotatable relative to the disk about a pitch axis, by virtue of the plurality of fan blades being operatively coupled to an actuation member.

Referring still to the exemplary embodiment of FIG. 5, the disk 130 is covered by rotatable front hub 136 aerodynamically contoured to promote an airflow through the plurality of fan blades 128. Additionally, the exemplary fan section 102 includes an annular fan casing or outer nacelle 138 that circumferentially surrounds the fan 126 and/or at least a portion of the turbine engine 104. The nacelle 138 is supported relative to the turbine engine 104 by a plurality of circumferentially-spaced outlet guide vanes 140. A downstream section 142 of the nacelle 138 extends over an outer portion of the turbine engine 104 so as to define a bypass airflow passage 144 therebetween.

Referring still to FIG. 5, the fan blades 128, disk 130, and front hub 136 are together rotatable about the longitudinal axis 101 directly by the LP spool 124. Accordingly, for the embodiment depicted, the turbofan engine 100 may be referred to as a “direct drive” turbofan engine. However, in other embodiments, the turbofan engine 100 may additionally include a reduction gearbox for driving the fan 126 at a reduced rotational speed relative to the LP spool 124.

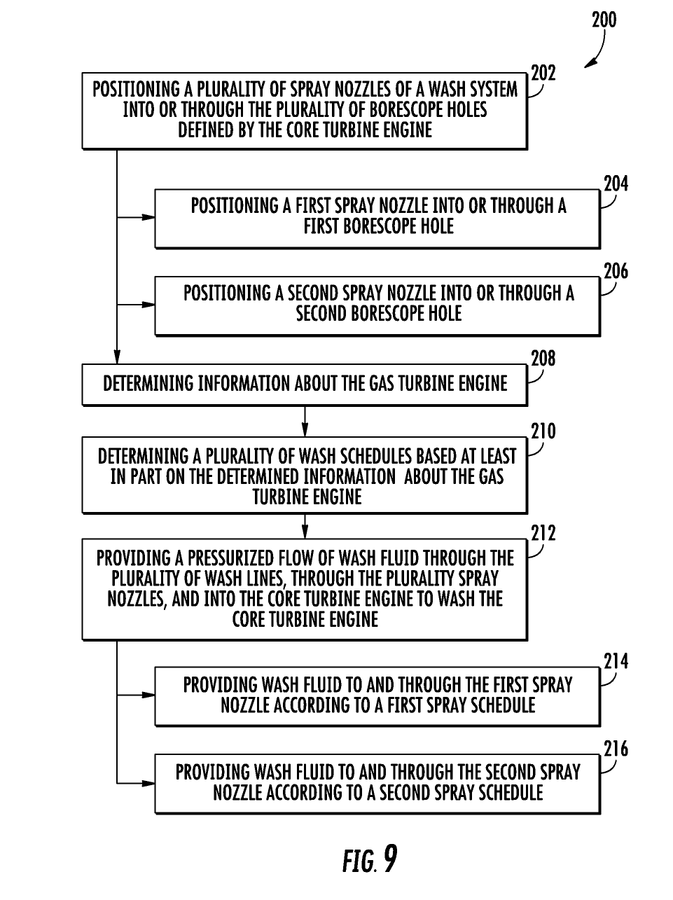

Throughout the turbofan engine 100, the turbine engine 104 defines a plurality of borescope holes 146. Specifically, for the embodiment depicted, the turbine engine 104 includes one or more borescope holes 146 defined in the compressor section, in the combustion section 114, and in the turbine section. More specifically, still, for the embodiment depicted, the turbine engine 104 includes one or more borescope holes 146 defined in the LP compressor 110, the HP compressor 112, a combustion chamber 154 of the combustion section 114, the HP turbine 116, and the LP turbine 118. The borescope holes 146 may allow for inspection of the turbine engine 104 between operations, and more specifically, may open into the core air flowpath 121 of the turbofan engine 100 to allow for inspection of, e.g., one or more blades, nozzles, or combustion liners of the turbofan engine 100 between operations. By contrast, during normal operations, the borescope holes 146 within the combustion section 114 and turbine section may be plugged with a borescope plug (not shown), such that the borescope holes 146 do not affect operation of the turbofan engine 100. Additionally, in certain exemplary aspects, as will be describe in greater detail below, the borescope holes 146 defined in the combustion section 114 may double as an opening for an igniter of the combustion section 114 (see FIG. 8).

Moreover, as previously stated, the exemplary turbofan engine 100 is depicted schematically as being cleaned by the power wash module 14 of the water wash system 10. More specifically, the power wash module 14 of the water wash system 10 further includes a plurality of spray nozzles 74, each of the plurality of spray nozzles 74 attached to a respective wash line 58 and configured for extending at least partially into or through one of the borescope holes 146 of the turbofan engine 100 for providing at least a portion of the flow of the pressurized wash liquid to the turbofan engine 100. More specifically, the plurality of spray nozzles 74 may provide at least a portion of the flow of pressurized wash liquid directly to the core air flowpath 121 of the turbine engine 104, at a location downstream from the inlet 108.

Referring still to FIG. 5, for the embodiment depicted, the plurality spray nozzles 74 includes a compressor spray nozzle 74A for extending at least partially into or through one of the borescope holes 146 defined in the compressor section of the turbofan engine 100, as well as a turbine spray nozzle 74B for extending at least partially into or through one of the borescope holes 146 defined in the turbine section of the turbofan engine 100. Further, for the embodiment depicted, the plurality spray nozzles 74 includes a combustion section spray nozzle 74C for extending at least partially into or through one of the borescope holes 146 defined in a combustion chamber 154 of the combustion section 114 of the gas turbine engine.

More specifically, for the embodiment depicted, the compressor spray nozzle 74A includes a plurality of compressor spray nozzles 74A (a first plurality of spray nozzles 74 positioned within borescope holes 146 in a first region of the turbofan engine 100), with at least one spray nozzle 74A extending into or through a borescope hole 146 defined in the LP compressor 110 and at least one spray nozzle 74A extending into or through a borescope hole 146 defined in the HP compressor 112. Further, for the embodiment depicted, the turbine spray nozzle 74B includes a plurality of turbine spray nozzles 74B (a second plurality of spray nozzles 74 positioned within borescope holes 146 in a second region of the turbofan engine 100), with at least one spray nozzle 74B extending into or through a borescope hole 146 defined in the HP turbine 116 and at least one spray nozzle 74B extending into or through a borescope hole 146 defined in the LP turbine 118.

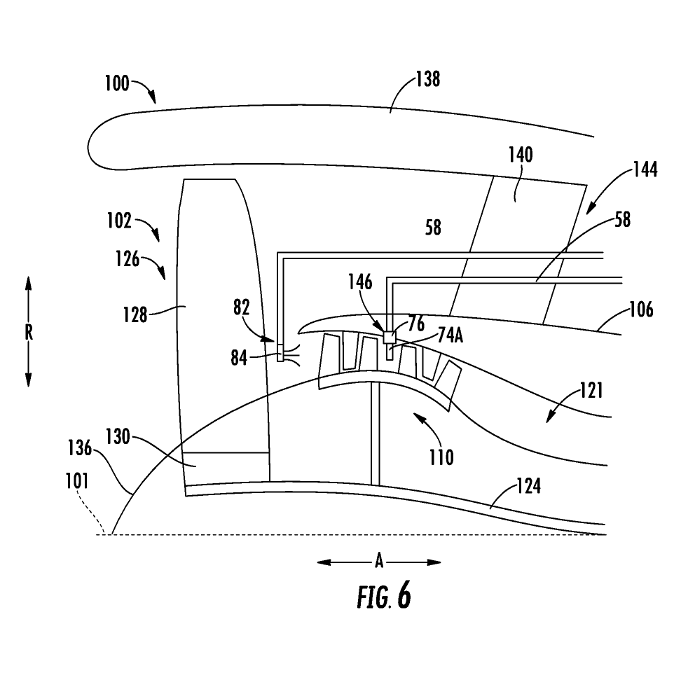

Further, referring now also to FIG. 6, providing a close-up view of a forward end of the turbofan engine 100 of FIG. 5, it will be appreciated that in at least certain exemplary aspects, each of the plurality of spray nozzles 74 may be configured to be attached to the turbine engine 104 at a respective borescope hole 146. More specifically, as is depicted schematically, the compressor spray nozzle 74 extending through the borescope hole 146 defined in the LP compressor 110 includes an attachment portion 76 which may be attached to the borescope hole 146. For example, the attachment portion 76 of the compressor spray nozzle 74 may screw into the borescope hole 146, providing a substantially air-tight and water-tight connection to the borescope hole 146. Such a configuration may allow for the spray nozzle 74 to provide at least a portion of the pressurized wash liquid to the core air flowpath 121 without such wash liquid reaching an undercowl area of the turbine engine 104.

Additionally, as is also depicted in FIGS. 5 and 6, the exemplary power wash module 14 further includes an inlet nozzle assembly 82 fluidly connected to one or more of the plurality of wash lines 58 for providing at least a portion of the flow of pressurized wash liquid to the turbofan engine 100, or rather to the turbine engine 104, through the inlet 108 of the turbine engine 104. As is depicted, the inlet nozzle assembly 82 includes one or more inlet nozzles 84 positioned proximate the inlet 108 to the turbine engine 104 to spray wash liquid directly into and through the inlet 108 of the turbine engine 104. In other exemplary embodiments, however, the inlet nozzle assembly 82 may instead be located at least partially forward of the fan 126.

Referring now to FIG. 7, providing a cross-sectional view through the LP compressor 110 of the turbofan engine 100 of FIG. 5, it should be appreciated, that in certain embodiments, the plurality of spray nozzles 74 may extend at least partially into or through borescope holes 146 of the turbofan engine 100 at locations spaced along, e.g., the circumferential direction C of the turbofan engine 100. More specifically, as is depicted in FIG. 7, the turbofan engine 100 includes a plurality of borescope holes 146 defined by the turbine engine 104 and spaced along the circumferential direction C. Additionally, the power wash module 14 of the water wash system 10 includes a plurality of compressor spray nozzles 74A extending at least partially into or through such borescope holes 146 spaced along the circumferential direction C. Such a configuration may allow for a more even cleaning of the turbofan engine 100, or rather of the turbine engine 104, during such wash operations. It should be appreciated, however, that although the exemplary cross-sectional view of FIG. 7 is depicted through a portion of the LP compressor 110, in other embodiments, one or more of the HP compressor 112, HP turbine 116, and LP turbine 118 may additionally include borescope holes 146 spaced along the circumferential direction C with spray nozzles 74 (including, e.g., nozzles 74A, 74B, and/or 74C) extending at least partially therethrough. Although the embodiment of FIG. 7 includes four borescope holes 146, in other embodiments, the turbine engine 104 may include any other suitable number borescope hole 146 spaced along the circumferential direction C.

Further, referring now to FIG. 8, a close-up, schematic view is depicted of the combustion section 114 of the exemplary turbofan engine 100 of FIG. 5. As is depicted, the combustion section 114 generally includes a combustor 148 having an inner liner 150 and an outer liner 152, and defining a combustion chamber 154 therebetween. The combustor 148 further includes a fuel nozzle 156 positioned proximate a forward end of the combustor 148, and an aft end of the combustor 148 is positioned adjacent to the HP turbine 116. For the embodiment depicted, the combustor 148 defines a borescope hole 146 through an outer casing 158 and through the outer liner 152. The combustion section spray nozzle 74C extends at least partially into or through the borescope hole 146 defined by the combustor 148. Notably, however, during operation of the turbofan engine 100, the borescope hole 146 is not plugged with a borescope plug (as with the other borescope holes 146). Instead, the exemplary borescope hole 146 defined by the combustor 148 is configured as an igniter hole configured to receive an igniter (not shown) for the combustor 148 during operation of the turbofan engine 100.

Referring now briefly back to FIG. 5, as noted above, the exemplary turbofan engine 100 includes the outer nacelle 138 which defines the bypass passage 144 with the turbine engine 104. For the embodiment depicted, the plurality of wash lines 58 extend from an aft end of the turbine engine 104, through the bypass passage 144 to each of the respective plurality of borescope holes 146, and to the inlet 108 for the inlet nozzle assembly 82. With such a configuration, the water wash system 10 may operate without having to remove one or more portions of the fan section 102. More specifically, a water wash system having such a configuration may allow for conducting washing operations (i.e., providing pressurized wash liquid through the plurality of wash lines and wash nozzles), while allowing for the turbofan engine to be cranked or rotated using, e.g., a starter motor, to increase in effectiveness of the washing operations.

Utilizing a water wash system in accordance with one or more of the exemplary embodiments described herein may allow for more efficient cleaning of the gas turbine engine. More specifically, by providing a wash liquid directly to a core air flowpath of the turbine engine of the gas turbine engine may allow the water wash system to provide such portions with heated and pressurized wash liquid. By contrast to prior configurations, in which wash liquid is provided solely at an inlet to the turbine engine (in which case such wash liquid may be neither pressurized nor heated by the time it reaches e.g., a turbine section), providing wash liquid directly to e.g., a turbine section of the turbine engine may allow the water wash system to provide heated and pressurized wash liquid to such section. Additionally, embodiments including the individual valves fluidly connecting wash lines to a pump in a nozzle distribution assembly may allow for relatively precise cleaning of the gas turbine engine and/or targeted cleaning of a gas turbine engine.

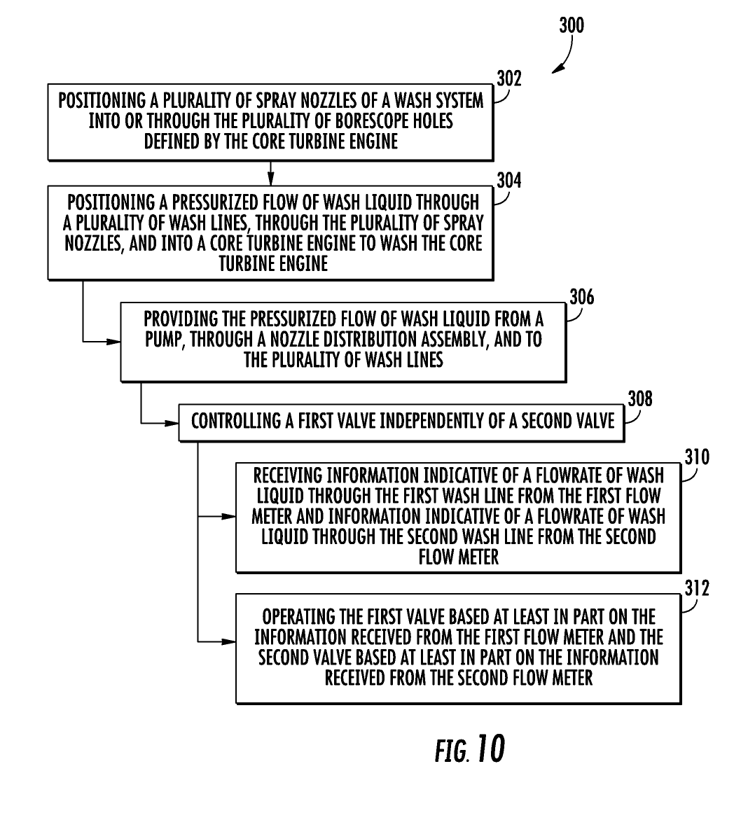

Referring now to FIG. 9, a flow chart is provided of an exemplary method (200) for washing a turbine engine. In at least certain exemplary aspects, the method (200) may be utilized with one or more of the water wash system 10 and/or power wash module 14 described above with reference to FIGS. 1 through 8. Moreover, in certain exemplary aspects, the method (200) may be utilized for washing a turbine engine configured in a manner similar to the exemplary turbofan 100 and turbine engine 104 described above with reference to e.g., FIG. 5. Accordingly, the turbine engine may include a compressor section, a combustion section, and a turbine section. Further, the turbine engine may define a plurality borescope holes located within one or more of the compressor section, combustion section, and turbine section.

As is depicted, the exemplary method (200) includes at (202) positioning a plurality of spray nozzles of a wash system into or through the plurality of borescope holes defined by the turbine engine. Each of the plurality of spray nozzles are fluidly connected to a respective plurality of wash lines of the wash system. Moreover, as will be appreciated, the plurality of wash lines may be fluidly connected to a nozzle distribution assembly, which is configured to receive a pressurized flow of wash liquid and distribute such pressurized flow of wash liquid to the plurality of wash lines.

In certain exemplary aspects, positioning the plurality spray nozzles into or through the plurality borescope holes at (202) may include positioning one or more of the plurality spray nozzles into or through a respective one or more of the plurality borescope holes defined by the turbine engine in the compressor section of the turbine engine, in the turbine section of the turbine engine, and/or in the combustion section of the turbine engine.

Moreover, for the exemplary aspect depicted, positioning the plurality spray nozzles into or through the plurality borescope holes at (202) further includes at (204) positioning a first spray nozzle into or through a first borescope hole, and at (206) positioning a second spray nozzle into or through a second borescope hole. In certain exemplary aspects, the first borescope hole may be defined by the turbine engine at a location forward of the second borescope hole. For example, the first borescope hole may be defined by the turbine engine in the compressor section, while the second borescope hole may be defined by the turbine engine in the turbine section.

Referring still to FIG. 9, the exemplary method (200) additionally includes at (208) determining information about the gas turbine engine, and at (210) determining a plurality of wash schedules based at least in part on the determined information about the gas turbine engine at (208). In at least certain exemplary aspects, each wash schedule corresponds to a respective wash line and spray nozzle of the wash system. Additionally, in certain embodiments, the information determined about the gas turbine engine at (208) may include a model number of the gas turbine engine. Accordingly such information may relate to the wash system a number and location of borescope holes, and/or recommended washing operations. Additionally, or alternatively, the information determined about the gas turbine engine at (208) may include a cleaning mode for the wash system. For example, the information may relate a length of time between cleanings, and/or areas of the gas turbine engine on which to focus. Further, the plurality of schedules determined at (210) may include one or more of a temperature of the wash liquid, a pressure of the wash liquid, a spray duration, a magnitude of wash fluid flow, a pressure of the wash fluid, and a velocity of wash fluid flow.

As is also depicted in FIG. 9, the exemplary method (200) further includes at (212) providing a pressurized flow of wash fluid through the plurality of wash lines, through the plurality spray nozzles, and into the turbine engine to wash the turbine engine. For example, in certain exemplary aspects, wherein the first spray nozzle is positioned in a first borescope hole at (204) and a second nozzle is positioned in a second borescope hole at (206), the providing a pressurized flow of wash fluid at (212) may further include at (214) providing wash fluid to and through the first spray nozzle according to a first spray schedule, and at (216) providing wash fluid to and through the second spray nozzle according to a second spray schedule. The first spray schedule may be different than the second spray schedule. For example, the first and second spray schedules may each include one or more of a temperature of the wash fluid, a pressure of the wash fluid, and a spray duration. Accordingly, wash fluid may be provided to and through the first spray nozzle at a different temperature, at a different pressure, and for a different spray duration than the wash fluid provided to and through the second spray nozzle. Such a method for washing turbine engine may allow for a more thorough cleaning of certain components if needed, and/or a more targeted cleaning of the turbine engine.

Referring now to FIG. 10, a flow chart is provided of another exemplary method (300) for washing a turbine engine. In at least certain exemplary aspects, the method (300) may operate similarly to the exemplary method (200) of FIG. 9, and accordingly may be utilized with one or more of the water wash system 10 and/or power wash module 14 described above with reference to FIGS. 1 through 8.

For example, the exemplary method (300) includes at (302) positioning a plurality of spray nozzles of a wash system into or through the plurality of borescope holes defined by the turbine engine. Additionally, the exemplary method (300) includes at (304) providing a pressurized flow of wash liquid through a plurality of wash lines, through the plurality of spray nozzles, and into a turbine engine to wash the turbine engine.

However, for the exemplary aspect depicted in FIG. 10, providing the pressurized flow of wash liquid at (304) includes at (306) providing the pressurized flow of wash liquid from a pump, through a nozzle distribution assembly, and to the plurality of wash lines. Additionally, for the exemplary aspect of FIG. 10, the nozzle distribution assembly includes a plurality of valves, with each of the plurality of valves fluidly connecting a respective wash line to the pump. More specifically, for the exemplary method (300) depicted, the plurality of valves of the nozzle distribution assembly includes at least a first valve and a second valve. The first valve fluidly connects a first wash line to the pump and the second valve fluidly connects a second wash line to the pump. For the exemplary aspect depicted, providing the pressurized flow of wash liquid at (304) further includes at (308) controlling the first valve independently of the second valve.

More specifically, for the exemplary aspect depicted, the nozzle distribution assembly further includes a first flow meter in fluid communication with the first wash line and a second flow meter in fluid communication with the second wash line. The method (300) further includes at (310) receiving information indicative of a flowrate of wash liquid through the first wash line from the first flow meter and information indicative of a flowrate of wash liquid through the second wash line from the second flow meter. The exemplary method (300) further includes at (312) operating the first valve based at least in part on the information received from the first flow meter and the second valve based at least in part on the information received from the second flow meter. Accordingly, the method (300) may operate the first valve in a feedback loop. Alternatively, however, the method (300) may operate the first valve to work separately in an open loop control method.

It should be appreciated, however, that in other exemplary aspects, the exemplary method (300) may additionally, or alternatively, operate the first valve independently of the second valve at (312) based on any other suitable information received.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

COMPONENT LIST

| Reference Character | Component |
|---|---|
| 10 | water wash system |
| 12 | Tank module |
| 14 | Power wash module |
| 16 | Foam wash module |
| 18 | Collection module |
| 20 | Control system |
| 22 | Computing device |
| 24 | Processor |
| 26 | Memory device |
| 28 | Instructions |
| 30 | Data |
| 32 | Communications interface |
| 34 | Wireless network |
| 36 | Wash tank |
| 38 | Outlet |
| 40 | quick release connection |
| 42 | Heater |
| 44 | Power source |
| 46 | Temperature sensor |
| 48 | Water level sensor |
| 50 | Pump |
| 52 | Controller |
| 54 | Pump of wash module |
| 56 | Nozzle distribution assembly |
| 58 | Wash lines |
| 60 | Fluid connection line |
| 62 | Power source |
| 64 | Outlet of pump |
| 66 | Duct |
| 68 | Sensor |
| 70 | Valve |
| 72 | Controller |
| 100 | Turbofan Jet Engine |
| 101 | Longitudinal or Axial Centerline |
| 102 | Fan Section |
| 104 | Core Turbine Engine |
| 106 | Outer Casing |
| 108 | Inlet |
| 110 | Low Pressure Compressor |
| 112 | High Pressure Compressor |
| 114 | Combustion Section |
| 116 | High Pressure Turbine |
| 118 | Low Pressure Turbine |
| 120 | Jet Exhaust Section |
| 121 | Core air flowpath |
| 122 | High Pressure Shaft/Spool |
| 124 | Low Pressure Shaft/Spool |
| 126 | Fan |
| 128 | Blades |
| 130 | Disc |
| 136 | Front hub |
| 138 | Nacelle |
| 140 | Outlet guide vanes |
| 142 | Downstream section |
| 144 | Bypass passage |
| 146 | Borescope holes |
| 148 | Combustor |
| 150 | Inner liner |
| 152 | Outer liner |
| 154 | Combustion chamber |
| 156 | Fuel nozzle |
| 158 | Outer casing |
| 160 | |
| 74 | Spray nozzle 74s |
| 74A | Compressor spray nozzle |
| 74B | Turbine spray nozzle |
| 74C | Combustion spray nozzle |
| 76 | Attachment portion |
| 78 | Valve |
| 80 | Flow meter |
| 82 | Inlet nozzle assembly |
| 84 | Inlet nozzles |
| 86 | |
| 88 | |
| 90 | |

What is claimed is:

1. A water wash system for a gas turbine engine, the gas turbine engine defining an axial direction and comprising a plurality of borescope holes, the water wash system comprising:
a pump configured to receive a flow of wash liquid and pressurize the flow of wash liquid;
a nozzle distribution assembly fluidly connected to the pump for receiving the flow of pressurized wash liquid;
a plurality of wash lines fluidly connected to the nozzle distribution assembly; and
a plurality of spray nozzles, each of the plurality of spray nozzles attached to a respective wash line and configured for extending at least partially into or through one of the borescope holes of the gas turbine engine for providing a portion of the flow of pressurized wash liquid to the gas turbine engine.

2. The water wash system of claim 1, wherein the plurality of spray nozzles includes a compressor spray nozzle for extending at least partially into or through one of the borescope holes defined in a compressor section of the gas turbine engine, and wherein the plurality of spray nozzles further includes a turbine spray nozzle for extending at least partially into or through one of the borescope holes defined in a turbine section of the gas turbine engine.

3. The water wash system of claim 2, wherein the compressor spray nozzle comprises a plurality of compressor spray nozzles.

4. The water wash system of claim 2, wherein the turbine spray nozzle comprises a plurality of turbine spray nozzles.

5. The water wash system of claim 2, wherein the plurality of spray nozzles further includes a combustion section spray nozzle for extending at least partially into or through one of the borescope holes defined in a combustor of a combustion section of the gas turbine engine.

6. The water wash system of claim 5, wherein the borescope hole defined in the combustor of the combustion section of the gas turbine engine is an igniter hole.

7. The water wash system of claim 1, wherein the plurality of spray nozzles are spaced along a circumferential direction of the gas turbine engine.

8. The water wash system of claim 1, further comprising:
an inlet nozzle assembly fluidly connected to one or more of the plurality of wash lines for providing a portion of the flow of pressurized wash liquid to the gas turbine engine through an inlet of the gas turbine engine.

9. The water wash system of claim 1, wherein the pump, the nozzle distribution assembly, the plurality of wash lines, and the plurality of spray nozzles are each configured as part of a power wash module of the water wash system.

10. The water wash system of claim 9, further comprising:
a tank module comprising a wash tank for containing a wash liquid and defining an outlet, wherein the pump of the power wash module is releasably fluidly connected to the outlet of the wash tank of the tank module.

11. The water wash system of claim 10, wherein the power wash module further comprises a wash liquid connection line wherein the wash liquid connection line is releasably fluidly connected to the outlet of the wash tank module through a quick release connection.

12. The water wash system of claim 1, wherein the nozzle distribution assembly comprises a plurality of valves, wherein each of the plurality of valves fluidly connects a respective wash line to the pump.

13. The water wash system of claim 12, wherein each of the plurality of valves are operable independently of one another.

14. The water wash system of claim 12, wherein each of the plurality of valves are configured as variable throughput valves.

15. The water wash system of claim 12, wherein each of the plurality of valves are configured as either a solenoid valves, or a ratio regulation valve.

16. The water wash system of claim 12, wherein the nozzle distribution assembly further comprises a plurality of flow meters, wherein each flow meter is in fluid communication with a respective wash line to measure a flowrate of the pressurized wash liquid flowing therethrough.

17. The water wash system of claim 12, wherein the plurality of spray nozzles includes a first plurality of spray nozzles for extending at least partially into or through borescope holes defined in a first region of the gas turbine engine, and wherein the plurality of spray nozzles further includes a second plurality of spray nozzles for extending at least partially into or through borescope holes defined in a second region of the gas turbine engine, wherein each of the plurality of valves are operable independent of one another to provide a wash fluid through the first plurality of spray nozzles according to a first spray schedule and wash fluid through the second plurality of spray nozzles according to a second spray schedule, wherein the first spray schedule is different than the second spray schedule.

18. The water wash system of claim 17, wherein the first spray schedule includes at least one of a magnitude of wash fluid flow, a velocity of wash fluid flow, a pressure of wash fluid, and a temperature of the wash fluid, and wherein the second spray schedule includes at least one of a magnitude of wash fluid flow, a velocity of wash fluid flow, a pressure of wash fluid, and a temperature of the wash fluid.

19. A gas turbine engine assembly comprising:
a turbine engine comprising a compressor section, a combustion section, and a turbine section in serial flow communication, wherein the turbine engine defines a plurality of borescope holes located within one or more of the compressor section, the combustion section, and the turbine section; and
a wash system for washing the turbine engine comprising
a pump for receiving a flow of wash liquid and pressurize the flow of wash liquid;
a nozzle distribution assembly fluidly connected to the pump for receiving the flow of pressurized wash liquid;
a plurality of wash lines fluidly connected to the nozzle distribution assembly; and
a plurality of spray nozzles, each of the plurality of spray nozzles attached to a respective wash line and extending at least partially into or through one of the borescope holes of the gas turbine engine for providing a portion of the flow of pressurized wash liquid to the turbine engine.

20. The gas turbine engine assembly of claim 19, wherein the turbine engine defines a circumferential direction, and wherein the plurality of spray nozzles are spaced along the circumferential direction of the turbine engine.
